(19) United States
(12) Patent Application Publication
(10) Pub. No.: US 2015/0206611 A1
(43) Pub. Date: Jul. 23, 2015

(54) DEVICE FOR IRRADIATION OF SAMPLES IN THE CORE OR AT THE PERIPHERY OF THE CORE OF A REACTOR

(71) Applicant: Commissariat à I'énergie atomique et aux énergies alternatives, Paris (FR)

(72) Inventors: Damien Moulin, La Tour D'Aigues (FR); Sébastien Christin, Leyment (FR)

(21) Appl. No.: 14/601,738

(22) Filed: Jan. 21, 2015

(30) Foreign Application Priority Data
Jan. 22, 2014 (FR) 14 50519

(51) Int. Cl. G21G 1/02

(52) U.S. Cl. CPC G21G 1/02

(57) ABSTRACT

Device to irradiate a sample in the core or at the periphery of the core of a nuclear reactor comprising, a double wall containment (6) delimiting a chamber (7), a receptacle (4) contained in said chamber (7), said receptacle being held at a distance from an inside wall (8) of the containment, said receptacle (4) being designed to contain a coolant, a sample holder (2), a free end of which will be located in the receptacle, in which the inside of the receptacle is in fluid communication with the outside of the receptacle and in which a volume between the inside wall (8) of the containment (6) and the receptacle (4) will be filled with a gas or a mix of gases called the coolant cushion gas.

### TECHNICAL FIELD AND PRIOR ART

This invention relates to a device for irradiation of materials in the core or at the periphery of the core of a nuclear reactor, and more particularly in a nuclear research reactor.

It must be possible to place materials or samples in a core or at the periphery of the core of a nuclear research reactor such that experiments can be carried out on them to observe their behaviour under irradiation.

Therefore it is required to have a device capable of introducing one (or several) samples(s) to be irradiated into the zone of the experimental reactor in which the neutron flux is highest, corresponding to the medium of fuel assemblies in the reactor. In this zone, samples and structures under irradiation are subjected to nuclear radiation (gamma and neutron) originating from the reactor core, which increases their temperature.

High temperatures and high pressures are applied to this experimental device.

It is difficult to choose materials capable of resisting high pressure and high temperature, for example of the order of 800° C., at the same time. This is particularly difficult under the irradiation conditions in the experiment.

For example, the life of austenitic steels is significantly shortened for temperatures higher than 450° C. For example, for X2CrNiMo17-12-2 austenitic steel, the life in a research reactor core under irradiation (typically with damage of 12 dpa/year) is 4.4 years below 375° C. and 2 years above 425° C. Similarly, material creep and aging below 450° C. are negligible regardless of the duration, but they become significant starting from 2000 hours at 525° C.

### PRESENTATION OF THE INVENTION

Consequently, one purpose of this invention is to provide an experimental device for irradiation of samples in a reactor in which samples can reach high temperatures while guaranteeing mechanical strength of the assembly to satisfy safety rules.

The purpose mentioned above is achieved by a device for irradiating samples comprising a chamber delimited by a double skin enclosure, the chamber containing a receptacle that will contain a coolant fluid, a sample holder penetrating into the receptacle such that the samples are immersed in the coolant fluid, the receptacle being capable of resisting high temperatures and the interior and exterior of the receptacle being in fluid communication such that the pressure inside the receptacle in which the sample holder is located and the pressure outside the receptacle are the same.

With the invention, the interior and exterior of the receptacle are at the same pressure, consequently the material(s) forming the receptacle will not have to resist a high pressure, therefore the material(s) from which it is made can be chosen to resist high temperatures and have a lower mechanical strength to resist pressure. Furthermore, gas outside the receptacle thermally isolates the chamber from the sample heating zone, it can then be made from a material or materials capable of resisting high pressure but capable of resisting a temperature lower than that in the receptacle.

Very advantageously, means of regulating the temperature of samples are provided in or on the receptacle wall. Preferably, these are additional sample heating means. This enables precise control of the temperature under sample irradiation conditions.

The mechanical strength of the containment depends on the pressure, temperature and irradiation time. According to the invention, the chamber is held at a temperature that does not significantly affect its mechanical strength due to the very smart use of the coolant cushion gas in which the samples are immersed as thermal insulation between the receptacle maintaining the temperature and the chamber, it can perform its safety function and the device can impose high temperatures on the samples. Thus sample temperatures of the order of 800° C. or even more can be reached with a relatively simple structure, while respecting nuclear safety rules, i.e. keeping a double skin containment.

The subject-matter of this invention is then a device to irradiate a sample in the core or at the periphery of a core of a nuclear reactor comprising,
a double wall containment delimiting a chamber,
a receptacle contained in said chamber, said receptacle being held at a distance from an inside wall of the containment, said receptacle being designed to contain a coolant,
a sample holder, a free end of which will be located in the receptacle,

in which the inside of the receptacle is in fluid communication with the outside of the receptacle and in which a volume between the containment inside wall and the receptacle will be filled with a gas or a mix of gases called the coolant cushion gas.

The containment may have an outside wall that will be in contact with a coolant of the reactor, and delimiting a gas volume with the inside wall.

In one advantageous example, the device comprises thermal regulation means installed on the receptacle.

The thermal regulation means may advantageously comprise at least additional heating means.

For example, the additional heating means comprise at least one heating element on the outside surface of the receptacle or preferably, several heating elements distributed over all or some of the outside surface of the receptacle.

For example, heating elements are distributed over all or part of the outside surface of the receptacle along the longitudinal axis such that the different zones of the receptacle along the longitudinal axis can be heated separately.

Preferably, the thermal control means are coated with a protective coating made for example by a sprayed-on process.

According to one additional characteristic, the device may comprise at least one temperature sensor installed on the receptacle, for example a thermocouple.

The inside of the receptacle may be in fluid communication with the outside of the receptacle at a top end of the receptacle through which the sample is inserted into the receptacle.

For example, the inside and outside walls and the receptacle are tubular in shape and are closed at a lower end by a bottom.

The inside and outside walls of the envelope may for example be made of X2CrNiMo17-12-2 stainless steel and the receptacle may be made of Inconel®718.

Another subject-matter of the invention is a method of irradiating a sample making use of a device according to the invention, comprising the following steps:
put at least one sample into position in the receptacle by inserting the sample holder in the device, the receptacle containing a coolant fluid,
put the device into position in the core or at the periphery of the core of a nuclear reactor,
remove the device from the reactor and remove the at least one sample from the device.

In one example, the coolant is a liquid, for example it may be a liquid metal or a liquid alloy, for example NaK or Na, and the coolant cushion gas is located between the containment and the receptacle.

In another example, the coolant is a gas or a mix of gases.

Additional heat may be input into the sample during irradiation.

### BRIEF DESCRIPTION OF THE DRAWINGS

This invention will be better understood after reading the following description and the appended drawings in which:

FIG. 1 is a longitudinal sectional view of a diagrammatic representation of an example embodiment of a device for irradiation of a sample according to the invention,

FIG. 2 is a detailed view of FIG. 1,

FIG. 3A is a graphic view of the temperature variation within the device as a function of the radius of the device, in the case of a liquid coolant,

FIG. 3B is a graphic representation of the temperature variation within the device as a function of the radius of the device in the case of a gas coolant,

FIG. 4 is a diagrammatic view of an example embodiment of additional heating means that can be used in the device according to the invention,

FIGS. 5A and 5B are diagrammatic representations of another example embodiment of additional heating means that can be used in the device according to the invention,

FIG. 6 is a representation of an example of a profile of the variation of the thickness of the gas gap between the receptacle and the internal surface of the containment.

### DETAILED PRESENTATION OF PARTICULAR EMBODIMENTS

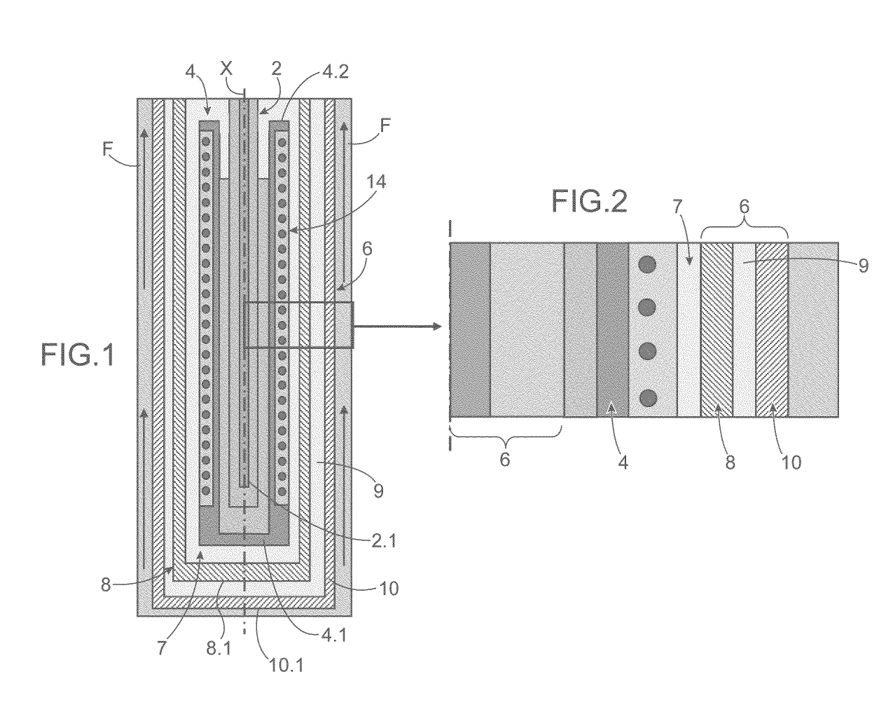

FIG. 1 shows a diagrammatic representation of a device for the irradiation of samples in a nuclear research reactor, more particularly in the core or at the periphery of the core of a nuclear research reactor.

The irradiation device and the elements that form part of it are advantageously in the form of a shape of revolution about a longitudinal axis X. The device comprises several preferably tubular concentric elements.

The length of the irradiation device is several meters (for example 5 m), and it comprises a longitudinal portion that will be located in the neutron flux zone corresponding to reactor fuel assemblies, that for example extends over a height of 1 m.

FIGS. 1 and 2 show the portion that will be placed in the neutron flux zone and that will be described in detail.

The device comprises a sample holder 2 with axis X comprising a free longitudinal end 2.1 that will hold the samples in position, this free longitudinal end 2.1 for example comprises a threaded rod or means of holding a structure adapted to the geometry of samples, to place them and to remove them. Each sample holder is designed to satisfy the specific needs of the experiment, for example it may include actuators for stressing the samples. It may also include different measurement sensors necessary to monitor the experiment under irradiation, for example to measure the temperature, pressure, variation of sample dimensions, neutron flux and gamma flux, etc. The sample holder 2 may be inserted and removed by sliding along the longitudinal axis X to change the sample.

The device also comprises a receptacle 4 inside which the free longitudinal end 2.1 of the sample holder is placed when the samples are in position. The receptacle will contain a coolant fluid inside which the samples are immersed and through which heat exchanges are made. The receptacle comprises a closed lower end 4.1 and an open upper end 4.2 through which the sample holder 2 is inserted. The lower end 4.1 may for example be welded to the side wall of the receptacle.

The coolant transfers heat exchanges between the samples, the receptacle and the containment in contact with the reactor coolant.

The distance between the end 4.1 of the receptacle and the end 8.1 of the lower tubular wall is such that free expansion is possible between the reservoir and the containment.

The receptacle 4 can also advantageously hold the measurement sensors, for example temperature and/or irradiation sensors.

The device also comprises a double wall containment 6 delimiting a chamber 7 for the receptacle.

The containment comprises an inner tubular wall 8 and an outer tubular wall 10, the two walls 8, 10 being concentric. Each tubular wall 8, 10 is closed at its lower end by a lower end 8.1, 10.1 respectively. For example, the lower ends 8.1, 10.1 are welded to one end of each tubular wall. The distance between the lower ends 8.1, 10.1 is such that free expansion is possible. The upper part of the receptacle is fixed to the inner wall of the containment by an appropriate mechanical means, free expansion being possible downwards.

Centring means are advantageously provided to maintain an approximately constant gas gap 9 between the two tubular walls over the entire height of the containment. For example, the distance between the inner face of the outer tubular wall 10 and the outer face of the inner tubular wall when cold may be of the order of 0.2 mm.

The two walls 8, 10 define a volume between them that will contain containment gas.

The volume defined between the two walls is closed. Gas may be inserted through a small diameter tubular hole, for example with inside diameter of 2 mm near the top of the containment.

When a liquid coolant such as a liquid metal like NaK (sodium and potassium alloy) is used and fills the bottom of the receptacle 4, the chamber 7 is filled with an inert gas such as helium, or a mix of gases compatible with the coolant. The upper part of the receptacle is filled with this gas or mix of gases called the coolant cushion gas, and since the inside of the receptacle is free to communicate with the chamber 7 through the upper end of the receptacle, the chamber 7 is filled with this coolant cushion gas.

The liquid coolant may be one or more liquid metals such as Sodium, one or more liquid alloys such as NAK, one or more salts, one or several organic liquids, etc.

Throughout the remainder of this description, the expression “upper cushion gas” refers to a gas or a mix of gases.

When a gas coolant for example such as helium is used in the receptacle, this gas also fills the chamber 7. The coolant may be a gas or a mix of gases.

The inner face of the inner tubular wall 8 is in contact with the coolant cushion gas.

The outer face of the outer tubular wall 10 is in contact with the coolant fluid of the research reactor, for example water that circulates along the direction symbolized by arrows F.

Advantageously, temperature regulation means 14 of the coolant contained in the receptacle are provided in or on the wall of the receptacle. For example, it may be heating means, or alternatively cooling means could be provided, or heating means and cooling means could both be provided.

The heating means may for example be composed of heating elements based on the Joule effect. Example embodiments of these means are described below.

Tubular walls 8, 10 are made from a material capable of resisting high pressures, for example of the order of 16 bars for the diameter values given in table 1 below.

For example they may be made of stainless steel, zirconium alloy or nickel alloy. The inner tubular wall 8 and the outer tubular wall 10 may be made from the same material or from different materials.

For example, the tubular walls 8, 10 may be made from X2CrNiMo17-12-2 stainless steel.

The receptacle is made from a material capable of resisting high temperatures, for example of the order of at least 800° C. with low strain, it may be a metallic material such as nickel alloys (for example Inconel®, Incoloy®), or stainless steels.

Moreover, centring means are advantageously provided to guarantee a uniform gas gap over the entire height of the heating zone between the outer surface of the receptacle and the inner tubular wall 8 of the containment of the device. This gas gap may have a constant thickness over the entire height of the receptacle or on the contrary, it may comprise longitudinal sections with different thicknesses along the receptacle. Centring means are provided on the surface of the receptacle, with small dimensions to limit thermal bridges. They may be metal bushings or ceramic centring systems.

We will now describe operation of this device.

The samples are fixed at the free end 2.1 of the sample holder 2 that is then inserted inside the device, in the receptacle 4 that contains the coolant fluid.

The device is then inserted into the research reactor core or at the periphery of the core. The device is then immersed in the reactor coolant fluid. The device is subjected to nuclear radiation (gamma and neutron radiation) that heats the different elements of the device and the coolant contained in the receptacle. The samples are also heated. The temperature regulation means may be activated for example to increase the temperature of the sample by heating the coolant. For example, this is about −800° C. in the case of a liquid coolant. The material of the receptacle is such that the receptacle can resist high temperatures. The receptacle 4 is surrounded by coolant cushion gas.

The coolant cushion gas contained in the chamber 7 forms a thermal insulation between the receptacle, i.e. the high temperature zone and the inner tubular wall 8, which limits the temperature applied to the tubular wall 8 and more generally to the containment, for example the temperature may be of the order of 350° C. Consequently, the materials used for the containment, although they are embrittled by irradiation, maintain sufficiently high mechanical properties such that the chamber can resist the mechanical stresses imposed by the pressure difference between the inside and the outside. It is thus possible to reach high temperatures at the centre of the device for the sample while maintaining mechanical strength of the device.

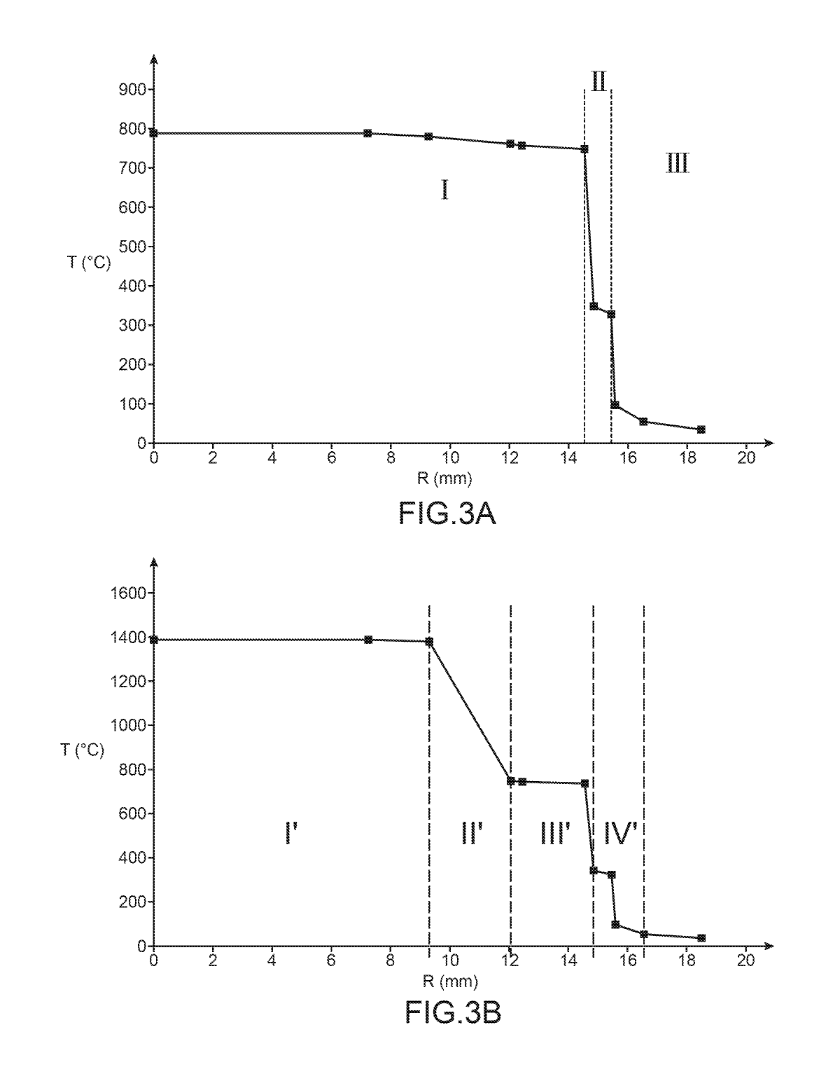

FIGS. 3A and 3B show graphic representations of the temperature in ° C. in the device along its radius R in mm, the device being under irradiation.

In the case in FIG. 3A, the coolant is NaK liquid metal and the reactor coolant is water, for a nuclear power of 12.5 W/g and an electric power of 200 W/cm.

It can be seen that in a central zone denoted I with radius less than about 14.55 mm the temperature is approximately constant and is about 800° C. Between 14.55 mm and 15.6 mm, this zone is denoted II and it is approximately equal to the outer diameter of the receptacle and the inner tubular wall of the containment 8, the temperature in the gas space 7 drops to about 350° that corresponds to the temperature of the inner tubular wall 8, and the temperature in the gas space 9 between the two containment walls drops to 100° C. at the outer tubular wall 10. Beyond this, the temperature in zone III starting from the tubular wall 10 and then outside the containment 4 in which the reactor coolant circulates, reduces more slowly to reach the temperature of the reactor coolant.

In the case shown in FIG. 3B, the coolant is helium and the reactor coolant is water, for a nuclear power of 12.5 W/g and an electric power of 200 W/cm. Even higher temperatures can be obtained by using a gas as a coolant because temperatures of the order of 1400° C. are reached at the centre of the device (Zone I′).

It can be seen that the temperature in a central zone denoted I′ corresponding to the samples, with a radius less than about 9.3 mm is about 1400° C. and is approximately constant. Then at between 9.3 mm and 12 mm, the zone II′ corresponds to the temperature drop in the coolant gas inside the receptacle. The temperature in the receptacle (zone III′) between 12 mm and 14.6 mm remains constant at about 750° C. and then drops in the gas space 7. The temperature of the inner tubular wall 8 in the containment (zone IV′) between 14.9 mm and 16.6 mm is about 350° C., and it then drops again in the gas space 9 to 100° C. at the outer tubular wall 10. Beyond this, the temperature drops more slowly to reach the temperature of the reactor coolant outside the containment 4.

The coolant gas conducts much less well than the coolant NaK and heat exchanges are not as good, such that the temperature of samples can be higher than in the case of NaK. Furthermore, the temperature drop is more important in the gas coolant than in NaK, which explains the difference in the profile between the curves in FIGS. 3A and 3B.

The efficiency of the device according to the invention then becomes obvious because the temperatures of the containment are temperatures at which its mechanical properties are maintained.

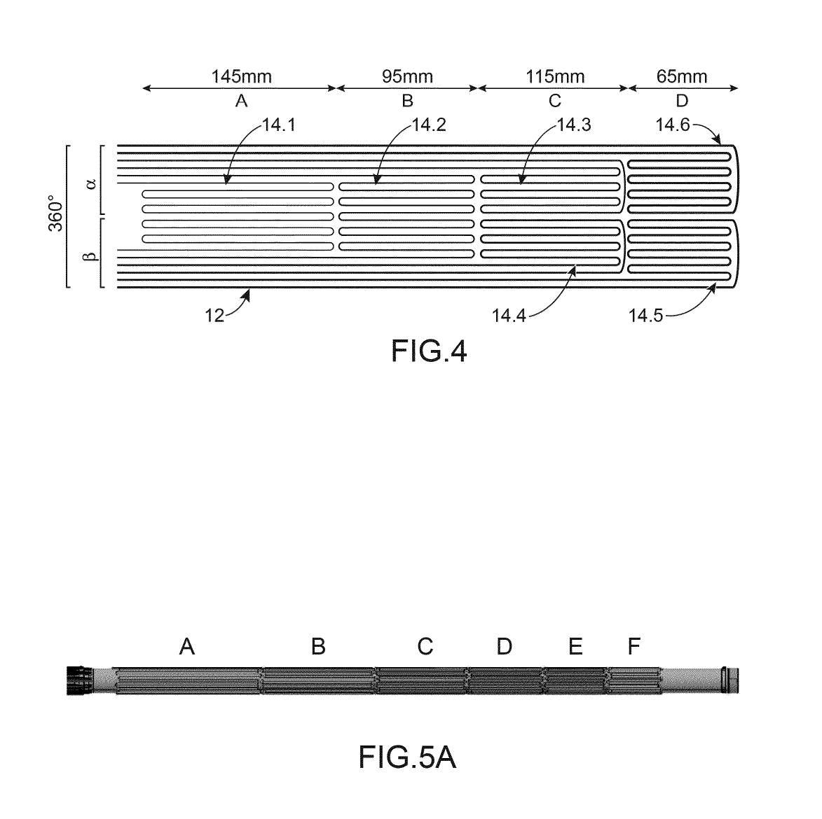

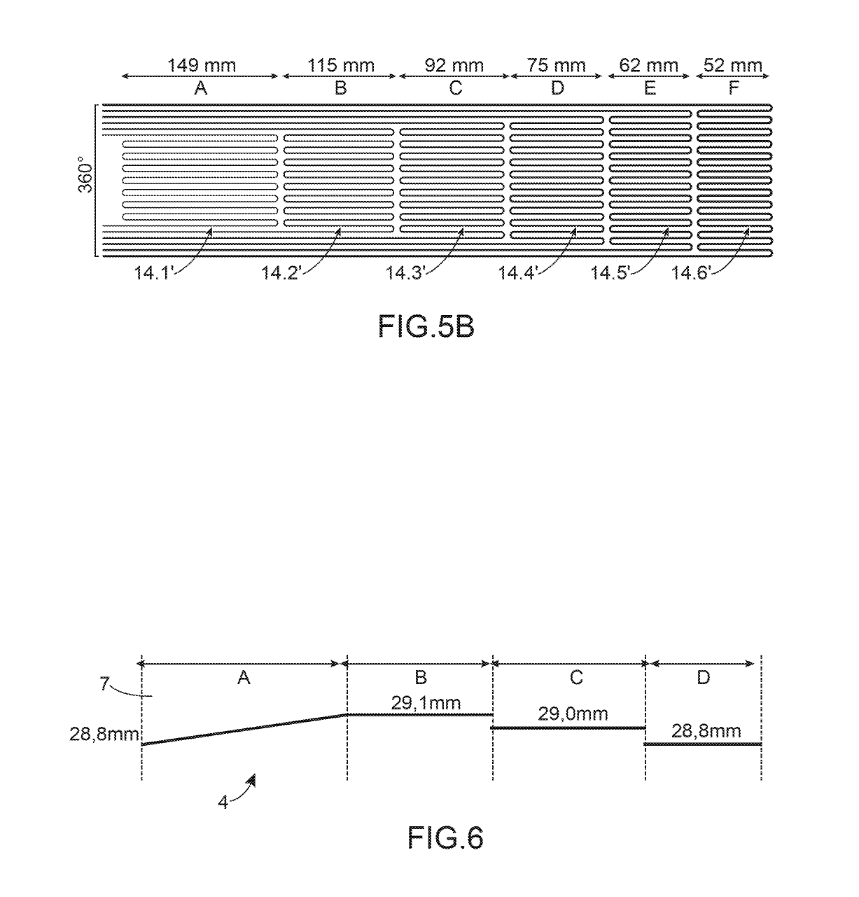

FIGS. 4 and 5A-5B show example embodiments of temperature regulation means formed by heating means. These are shown in a developed view.

In FIG. 4, the heating means comprise heating elements in wire form, for example in the example shown there are six distinct heating wires denoted 14.1 to 14.6. The power supply ends of the wires are all located at the same end of the receptacle, preferably the upper end so that they can be connected to a power supply source. Each wire is made to meander on the outer surface of the receptacle so that all or part of the height of the receptacle and all or part of its perimeter is covered uniformly. The heating elements are distributed over the height of the receptacle such that six axially distributed heating zones are defined. These six zones can be controlled separately. Axial zones C and D each comprise two heating elements 14.3 and 14.4, and 14.5 and 14.6 respectively. Preferably, heating elements 14.3 and 14.4 are controlled to achieve uniform heating of zone C, and heating elements 14.5 and 14.6 are controlled so as to achieve uniform heating of zone D.

As a variant, a single heating wire could be applied covering the entire height and the entire periphery of the receptacle. An arbitrary number of heating wires may be used. Furthermore, heating wires extending over the entire height of the receptacle but only covering an angular portion of the periphery of the receptacle lie within the scope of this invention. The use of several independent zones makes it possible to modulate heat input depending on axial and radial nuclear heating gradients. Furthermore, by using a single element, it would be more difficult to provide the entire required power. Furthermore, if several elements are used, it is always possible to add more heat if one of the two elements is defective.

Any additional heating means compatible with the geometry, the nuclear medium and the coolant may be used, for example an induction or a resistive tube heating means, etc.

FIG. 5A shows another embodiment of the heating means also comprising six wires distributed differently. FIG. 5B shows a side view of the receptacle comprising the heating means in FIG. 5A. The six heating elements 14.1′ to 14.6′ are distributed in the six axial zones A to F.

For example, the outside surface of the receptacle is machined to act as support for the heating wires. For example, the wires are single wire type and they comprise an 80/20 nickel chromium core for the part that will be heated by the Joule effect, an MgO mineral insulation and an Inconel®600 sheath. Machining may for example consist of reducing the outside diameter of the receptacle and/or etching to house the wires.

Advantageously, temperature sensors for example such as thermocouples, are also provided on the outside surface of the receptacle to control the temperature of the device.

Preferably, the heating means and the temperature sensors are coated with a protective coating, if necessary. This coating can transfer power input by the heating elements to the receptacle more efficiently while limiting the temperature rise of the heating elements to avoid damaging them. For example, a thin ceramic layer may be formed on the metal covering the heating elements (for example by a sprayed-on process that will be described below).

This coating can also provide a surface that can be ground so that the outside diameter can be controlled.

For example, the wires or the heating elements are located on the outside surface of the receptacle without etching and are coated.

The wire diameter is such that the final diameter of the receptacle is compatible with the containment that holds it and the gas gap separating them.

The coating is chosen in order to coat the heating elements and the temperature sensors and to have limited porosity and prevent oxidation of the metal. For example, this coating can be made by metallisation, advantageously the coating is made from an Inconel® type nickel alloy coating. The coating may be made of copper, as a variant.

This coating may be made by sprayed-on process. It can also be produced by moulding.

Sprayed-on process is well known to those skilled in the art. This consists of a surface treatment using a dry process, obtained by thermal spraying. Sprayed-on process includes several processes that have the common property that they melt a filler metal and then spray it in the form of droplets carried by a vector gas. The deposit is formed by successive stacking of droplets of the molten material or material in the paste state, resulting in a lamellar structure. Adhesion of the coating is obtained essentially by a mechanical phenomenon and the surface of parts is previously prepared to increase the roughness and improve bond.

A stabilization annealing is advantageously made after this coating has been formed on the outside surface of the receptacle. The coating thus formed is then machined to a constant diameter or to an axially variable profile to obtain a variable gas gap between the receptacle 4 and the containment 6, and an example of a variable gap profile is shown diagrammatically in FIG. 6. The given numeric values are examples of the outside diameter of the receptacle. This variable profile advantageously makes it possible to modulate heat exchanges in the axial direction. The variation in the gas gap preferably corresponds approximately to zones A, B, C and D of heating elements as can be seen by comparison with FIG. 4.

Cables for heating elements and thermocouples are routed above the heating zone, in the gas gap between the receptacle 4 and the containment 6.

As a non-limitative example, we will give design values of an example device for irradiation according to the invention.

The double envelope containment is composed of two tubular walls made of X2CrNiMo17-12-2 stainless steel.

Table 1 contains values of inside and outside diameters

TABLE 1

| | Inside diameter (mm) | Outside diameter (mm) |
|---|---|---|
| Inner tubular partition | 29.7 | 30.9 |
| Outer tubular partition | 31.2 | 33.1 |

For example, the receptacle is made of Inconel® 718. It is about 1 m long, its inside diameter is 24.1 mm and its outside diameter is 25.3 mm.

The outside side face of the receptacle 2 is machined to an outside diameter of 24.9 mm over about 700 mm to act as a support for six heating elements (EC). The heating elements are of the 80/20 nickel chromium single-wire type with an MgO mineral insulation and an Inconel® 600 jacket. In the examples given, the heating elements allow to increase the temperature by about 150° C. for the NaK coolant and about 75° C. for the gas coolant.

The axial space between heating zones A to D is of the order of 10 mm.

The heating length of the six heating elements is 1500 mm and the diameter is 1 mm. Twelve 1 mm diameter K type thermocouples are placed in the heating zones. The heating height is of the order of 450 mm.

After stabilization annealing, the metal coating obtained by a sprayed-on process is machined to a constant diameter, equal to 29.1 mm in the case described. The coating covers all heating elements and extends on each side of the heating elements, for example over a few centimetres.

For example, the receptacle is capable of maintaining a temperature of the order of 800° C. while containment envelopes can be made to resist a temperature of the order of 450° C. and for example a pressure of 16 bars for the diameters given in table 1.

It will be understood that considering the length of the device (compared with its transverse dimensions), special care is taken in making the inner and outer tubular walls of the receptacle so as to obtain very good concentricity and well-controlled thicknesses of the gas film in the containment and the gas film between the receptacle and the containment.

The irradiation device has a relatively simple structure and can be used to apply very high temperatures on samples while respecting safety rules.

1. Device to irradiate a sample in the core or at the periphery of the core of a nuclear reactor comprising,
a double wall containment delimiting a chamber,
a receptacle contained in said chamber, said receptacle being held at a distance from an inside wall of the containment, said receptacle being designed to contain a coolant,
a sample holder, a free end of which being configured to be located in the receptacle,
in which the inside of the receptacle is in fluid communication with the outside of the receptacle and in which a volume between the inside wall of the containment and the receptacle is configured to be filled with a gas or a mix of gases called the coolant cushion gas.

2. Device according to claim 1, in which the containment has an outside wall that is configured to be in contact with a coolant of the reactor, and delimiting a gas volume with the inside wall.

3. Device according to claim 1, comprising thermal regulator installed on the receptacle.

4. Device according to claim 3, in which the thermal regulator comprises at least an additional heater.

5. Device according to claim 4, in which the additional heater comprises at least one heating element on the outside surface of the receptacle.

6. Device according to claim 4, in which the additional heater comprises several heating elements distributed over all or part of the outside surface of the receptacle.

7. Device according to claim 6, in which the heating elements are distributed over all or part of the outside surface of the receptacle along the longitudinal axis such that the different zones of the receptacle along the longitudinal axis can be heated separately.

8. Device according to claim 3, in which the thermal regulator is coated with a protective coating.

9. Device according to claim 1, comprising at least one temperature sensor installed on the receptacle.

10. Device according to claim 9, in which the temperature sensor is a thermocouple.

11. Device according to claim 1, in which the inside of the receptacle is in fluid communication with the outside of the receptacle at a top end of the receptacle through which the sample is inserted into the receptacle.

12. Device according to claim 1, in which the inside wall and the outside wall and the receptacle are tubular in shape and are closed at a lower end by a bottom.

13. Device according to claim 1, in which the inside wall and the outside wall of the envelope are made of X2CrNiMo17-12-2 stainless steel and the receptacle is made of Inconel®718.

14. Method of irradiating a sample making use of a device according to claim 1 to, comprising the following steps
put at least one sample into position in the receptacle by inserting the sample holder in the device, the receptacle containing a coolant fluid,
put the device into position in the core or at the periphery of the core of a nuclear reactor,
remove the device from the reactor and remove the at least one sample from the device.

15. Irradiation method according to claim 14, in which the coolant is a liquid, for example it is a liquid metal or a liquid alloy, and the coolant cushion gas is located between the containment and the receptacle.

16. Irradiation method according to claim 15, in which the coolant is NaK or Na.

17. Irradiation method according to claim 16, in which the coolant is a gas or a mix of gases.

18. Irradiation method according to claim 14, in which additional heat is input into the sample during irradiation.

19. Irradiation method according to claim 15, in which the coolant is a liquid metal or a liquid alloy,
